(19) United States
(12) Patent Application Publication
(10) Pub. No.: US 2021/0011293 A1
(43) Pub. Date: Jan. 14, 2021

(54) IMAGE DISPLAY DEVICE AND DISPLAY DEVICE

(71) Applicant: SONY SEMICONDUCTOR SOLUTIONS CORPORATION, Atsugi-shi, Kanagawa (JP)

(72) Inventors: Midori KANAYA, Tokyo (JP); Tsuguhiro ABE, Kanagawa (JP)

(73) Assignee: Sony Semiconductor Solutions Corporation, Atsugi-shi, Kanagawa (JP)

(21) Appl. No.: 16/955,533

(22) PCT Filed: Nov. 30, 2018
(86) PCT No.: PCT/JP2018/044234

§ 371 Date: Jun. 18, 2020

(30) Foreign Application Priority Data
Dec. 26, 2017 (JP) 2017-249078

(51) Int. Cl. G02B 27/01; G02B 27/10

(52) U.S. Cl. CPC G02B 27/0172; G02B 2027/0178; G02B 2027/0174; G02B 27/1086

(57) ABSTRACT

An image display device 10 includes an optical splitter 11 to which an image emitted from an image forming device 21 placed in an outside (outside of the image display device 10) is injected and that is configured to divide the image into a plurality of images, and a light collecting element 12 configured to collect, on a pupil 32 of a viewer 31, a plurality of images divided by the optical splitter 11 and emitted from the optical splitter 11, and if a focal distance of the light collecting element 12 is denoted by F₀ (unit: mm) and an optical distance from the optical splitter 11 to the light collecting element 12 is by L₀ (unit: mm), L₀=F₀±10 is satisfied.

### TECHNICAL FIELD

The present disclosure relates to an image display device, and a display device including the image display device.

### BACKGROUND ART

A retinal projection display based on the Maxwellian view in which an image (a light flux) is directly projected on the retina of a viewer and thereby the image is displayed, specifically, a retinal projection head-mounted display (hereinafter, occasionally abbreviated as a “retinal projection HMD”) is widely known. Meanwhile, in such a retinal projection HMD, it is necessary that a point of light convergence be caused to be located on the pupil; however, the diameter of the pupil of a human being is 2 mm in a bright environment and 7 mm in a dark environment, and the range is very narrow. Therefore, it is necessary to strictly control the position of the image so that the image (the light flux) is incident on the pupil of the human being. Further, there is also a problem that, due to the movement of the eyeball, the mounting misalignment of the retinal projection HMD, etc., the image (the light flux) deviates from the pupil of the viewer and the image cannot continue to be viewed correctly.

There is disclosed a technology in which, in a retinal projection HMD, an optical splitter that splits light is provided on the optical path between an image forming device and an eyepiece that causes an image to converge on the pupil (for example, U.S. Pat. No. 5,701,132). In this technology, the problem mentioned above is solved by causing a plurality of images to converge on the pupil of a viewer by means of split fluxes of light.

### CITATION LIST

### Patent Document

Patent Document 1: U.S. Pat. No. 5,701,132

### SUMMARY OF THE INVENTION

### Problems to be Solved by the Invention

Meanwhile, it is difficult to provide an optical splitter between an image forming device and an eyepiece in a case of envisaging a retinal projection HMD of a style in which the technology disclosed in the published US patent document mentioned above is applied and the image forming device and the eyepiece are separated, that is, of a style in which the image forming device is placed in a place far away from the eyepiece (specifically, for example, in a case where a viewer wears the image forming device on the hand or in a case where the image forming device is provided in a facility in the outside and a viewer wears the eyepiece as an eyeglass). That is, in a case where the optical splitter is provided on the image forming device side, there is a problem that the distance between the optical splitter and the eyepiece is long; further, in a case where the optical splitter is provided on the eyepiece side, since the optical splitter needs to be provided outside the eyeglasses, there is a problem that it is difficult to reduce the size and weight of the retinal projection head-mounted display.

Thus, an object of the present disclosure is to provide a display device, such as a retinal projection HMD, having a configuration and a structure capable of achieving size and weight reduction, and an image display device to be included in a relevant display device.

### Solutions to Problems

In order to achieve the issues described above, according to a first aspect of the present disclosure, there is provided an image display device including:

an optical splitter to which an image emitted from an image forming device placed in an outside (outside of the image display device) is injected and that is configured to divide the image into a plurality of images; and

a light collecting element configured to collect, on a pupil of a viewer, a plurality of images divided by the optical splitter and emitted from the optical splitter,

in which, if a focal distance of the light collecting element is denoted by F₀ (unit: mm) and an optical distance from the optical splitter to the light collecting element is by L₀ (unit: mm),

L₀=F₀±10

is satisfied.

In order to achieve the issues described above, according to a second aspect of the present disclosure, there is provided an image display device including:

an optical splitter to which an image emitted from an image forming device placed in an outside is injected and that is configured to divide the image into a plurality of images; and

a light collecting element configured to collect, on a pupil of a viewer, a plurality of images divided by the optical splitter and emitted from the optical splitter,

in which, if an extension line of a center line of the pupil is taken as a Z-axis, a straight line connecting turning centers of left and right eyeballs is as an X-axis, and an axis orthogonal to the X-axis and the Z-axis and is as a Y-axis, the optical splitter and the light collecting element are provided in an imaginary plane parallel to an XY plane.

In order to achieve the issues described above, according to a third aspect of the present disclosure, there is provided an image display device including:

an optical splitter to which an image emitted from an image forming device placed in an outside is injected and that is configured to divide the image into a plurality of images; and

a light collecting element configured to collect, on a pupil of a viewer, a plurality of images divided by the optical splitter and emitted from the optical splitter,

in which the optical splitter is provided on an ear side of the viewer, and the light collecting element is provided on a nose side of the viewer.

A display device of the present disclosure for achieving the object mentioned above includes an image forming device and an image display device, and the image display device includes the image display device according to any of the first aspect to the third aspect of the present disclosure.

### BRIEF DESCRIPTION OF DRAWINGS

FIG. 1A and FIG. 1B are a conceptual diagram of an image display device and a display device of Example 1 and a schematic cross-sectional view of the image display device of Example 1, respectively.

FIG. 2A, FIG. 2B, and FIG. 2C are conceptual diagrams of the image display device and the display device of Example 1.

FIG. 3A and FIG. 3B are schematic cross-sectional views of modification examples of the image display device of Example 1.

FIG. 4A and FIG. 4B are schematic cross-sectional views of an image display device of Example 2 and a modification example thereof, respectively.

FIG. 5A and FIG. 5B are schematic cross-sectional views of other modification examples of the image display device of Example 2.

FIG. 6A and FIG. 6B are a schematic diagram of the image display device of Example 1 as seen from the front side and a schematic cross-sectional view of the image display device of Example 1 taken in an XZ plane, respectively.

FIG. 7A and FIG. 7B are conceptual diagrams of an image forming device of a first configuration and an image forming device of a second configuration, respectively.

FIG. 8 is a schematic diagram of a frame, etc. including the image display device of Example 1 as seen from the front side.

FIG. 9A and FIG. 9B are schematic diagrams of a state where a display device of Example 1 is being used in a room and a state where an image forming device is provided on the back surface of the back of each of seats, respectively.

FIG. 10A and FIG. 10B are schematic diagrams of a state where a display device of Example 3 is being used in a room and a schematic cross-sectional view of the image display device of Example 3 taken in an XZ plane, respectively.

FIG. 11 is a diagram for describing a method for fabricating a reflective volume hologram diffraction grating.

FIG. 12A is an enlarged schematic cross-sectional view showing part of a reflective volume hologram diffraction grating, and FIG. 12B and FIG. 12C are schematic partial cross-sectional views of a reflective blazed diffraction grating and a reflective blazed diffraction grating having step shapes, respectively (however, hatching lines are omitted).

### MODE FOR CARRYING OUT THE INVENTION

Hereinafter, the present disclosure will be described on the basis of examples, with reference to the drawings, but the present disclosure is not limited to the examples, and various numerical values or materials in the examples are merely an example. Furthermore, the present disclosure will be described in the following order.

1. Overall description of image display devices according to first aspect to third aspect of present disclosure and display device of present disclosure

2. Example 1 (an image display devices according to the first aspect to the third aspect of the present disclosure and a display device of the present disclosure)

3. Example 2 (modification of Example 1)

4. Example 3 (modification of Example 1 and Example 2)

5. Others

### OVERALL DESCRIPTION OF IMAGE DISPLAY DEVICES ACCORDING TO FIRST ASPECT TO THIRD ASPECT OF PRESENT DISCLOSURE AND DISPLAY DEVICE OF PRESENT DISCLOSURE

In the image display devices according to the first aspect to the third aspect of the present disclosure and the image display devices according to the first aspect to the third aspect of the present disclosure included in the display device of the present disclosure, the light collecting element causes a plurality of images divided by the optical splitter and emitted from the optical splitter to be collected on the pupil of the viewer; in a state where it is assumed that the position of the light collecting element and the position of the pupil of the viewer are relatively fixed, there is a case where all of the plurality of images is collected on the pupil of the viewer and there is also a case where part of the plurality of images is collected on the pupil of the viewer. However, if the light collecting element and the pupil of the viewer relatively move along an XY plane, the light collecting element can cause all of the plurality of images to be collected on the pupil of the viewer.

Further, in the image display device according to the first aspect of the present disclosure and the image display device according to the first aspect of the present disclosure included in the display device of the present disclosure, in a case where, for example, the optical splitter includes a diffraction grating, L₀ is defined as the optical distance from the optical splitter to the light collecting element (specifically, the optical distance between the facing surfaces of the optical splitter and the light collecting element) along the course of light that is emitted from the center of the image forming device, is incident on the optical splitter, is emitted as the 0-th order diffracted light from the optical splitter, and is incident on the light collecting element (for the sake of convenience, referred to as a “center light course”). The optical distance refers to the actual length of the optical path in a medium multiplied by the refractive index of the medium. It is preferable that the pupil of the viewer be located at the focus of the light collecting element; however, if no problem occurs in actual use, the pupil of the viewer may be located in a position slightly shifted from the focus of the light collecting element.

Further, in the image display device according to the second aspect of the present disclosure and the image display device according to the second aspect of the present disclosure included in the display device of the present disclosure, the center line of the pupil (the center line of the pupil of the eyeball of the viewer (a line-of-sight front-side light beam)) is a straight line that is parallel to the perpendicular bisector of a straight line (an X-axis) connecting the turning centers of the left and right eyeballs and that passes through the turning center of each eyeball. Alternatively, the center line of the pupil (a pupillary axis) is defined by a straight line that passes through the center of the entrance pupil of the eyeball and that is perpendicular to the surface of the cornea. Although the optical splitter and the light collecting element are provided in an imaginary plane parallel to an XY plane, the optical splitter and the light collecting element may not be provided in an imaginary plane parallel to a strictly identical XY plane. That is, also in a case where the optical splitter is provided in a first XY plane and the light collecting element is provided in a second XY plane, and the distance between the first XY plane and the second XY plane is, for example, not more than 30 mm, the optical splitter and the light collecting element are regarded as being provided in an imaginary plane parallel to the XY plane. Further, also in a case where the optical splitter is provided in a first XY plane and the light collecting element is provided in a second XY plane, and the first XY plane is inclined with respect to the second XY plane, the optical splitter and the light collecting element are regarded as being provided in an imaginary plane parallel to the XY plane.

In the display device of the present disclosure, it is possible to employ a form in which

a position display means is installed in the image display device,

a position detection means that detects the position of the position display means is provided in the image forming device, and

the position of an image emitted from the image forming device is controlled on the basis of the result of detection of the position of the position display means by the position detection means. Here, specifically, a retroreflection marker may be given as the position display means, and a light emitting diode that emits infrared rays and an infrared sensor or an infrared camera that detects infrared rays returning from the retroreflection marker may be given as the position detection means. It is preferable that a filter (an infrared transmission filter) that transmits infrared rays and blocks visible light be placed on the infrared incident side of the infrared sensor or the infrared camera. Then, if the position of the retroreflection marker and further the position of the image display device are detected by the position detection means and the position of an image emitted from the image forming device is controlled on the basis of the detection result, the image emitted from the image forming device can be surely caused to arrive at the optical splitter. Examples of the method for controlling the position of an image emitted from the image forming device include a method in which a movable mirror that an image emitted from the image forming device is incident on is placed and an image reflected by the movable mirror is caused to be incident on the optical splitter; however, the method is not limited to such a method.

In the image display devices according to the first aspect to the third aspect of the present disclosure, or the image display devices according to the first aspect to the third aspect of the present disclosure included in the display device of the present disclosure including the preferred forms mentioned above (hereinafter, these are collectively referred to as “the image display device, etc. of the present disclosure”), it is possible to employ a form in which a light beam included in an image incident on the optical splitter is substantially parallel light and also a light beam included in each of a plurality of images emitted from the optical splitter is substantially parallel light.

In the image display device, etc. of the present disclosure including the preferred forms mentioned above, it is possible to employ a form in which a plurality of images divided by the optical splitter and formed as images on the retina of the viewer is the same image.

Then, in the image display device, etc. of the present disclosure including the various preferred forms described hereinabove, it is possible to employ a configuration in which a plurality of images divided by the optical splitter is directly incident on the light collecting element. The space located between the optical splitter and the light collecting element may be occupied by air, or may be occupied by a base material (for example, a plastic material or glass). In a case of the former, it is sufficient that the optical splitter and the light collecting element be installed on an appropriate support member; in a case of the latter, it is sufficient that the optical splitter and the light collecting element be installed on the base material. Then, in such a configuration, it is possible to employ a configuration in which the optical splitter includes a reflective diffraction grating or a reflective hologram diffraction grating (specifically, a reflective volume hologram diffraction grating), or a transmission diffraction grating or a transmission hologram diffraction grating (specifically, a transmission volume hologram diffraction grating), and the light collecting element includes a hologram lens.

Alternatively, in the image display device, etc. of the present disclosure including the various preferred forms described hereinabove, it is possible to employ a configuration in which a plurality of images divided by the optical splitter is reflected once or more and is incident on the light collecting element. Then, in this case, it is possible to employ a configuration in which the optical splitter includes a transmission diffraction grating or a transmission hologram diffraction grating (specifically, a transmission volume hologram diffraction grating), or a reflective diffraction grating or a reflective hologram diffraction grating (specifically, a reflective volume hologram diffraction grating), the light collecting element includes a hologram lens, and a light reflection member that reflects, toward the light collecting element, light emitted from the optical splitter is further provided. A reflective diffraction grating member may be given as the light reflection member. Then, in this case, the space located between the optical splitter, the light reflection member, and the light collecting element may be occupied by air, or may be occupied by a base material (for example, a plastic material or glass). In a case of the former, it is sufficient that the optical splitter, the light reflection member, and the light collecting element be installed on an appropriate support member; in a case of the latter, it is sufficient that the optical splitter, the light reflection member, and the light collecting element be installed on the base material. Alternatively, it is also possible to employ a configuration in which a base material serves also as the light reflection member. Specifically, it is sufficient that the optical splitter and the light collecting element be installed on a base material, and a plurality of images divided by the optical splitter and propagating through the base material be caused to be totally reflected in the base material once or more and be caused to be incident on the light collecting element. Note that the term of “total reflection” means total internal reflection or total reflection in the base material.

Furthermore, in the image display device, etc. of the present disclosure including the various preferred forms and configurations described hereinabove, it is possible to employ a form in which the amount of displacement on the pupil of the viewer between a plurality of images divided by the optical splitter is not less than 2 mm and not more than 7 mm. Alternatively, it is preferable that

(mm)≤F₀·tan(θ)≤7 (mm)

be satisfied. Here, the angle between the light flux (referred to as “center light flux-A”) located at the center of, among the images divided by the optical splitter, the image located most on the inside (for the sake of convenience, referred to as “image-A”) and the light flux (referred to as “center light flux-B”) located at the center of the image located most on the inside symmetrically to image-A with the center light course as a symmetry axis (for the sake of convenience, referred to as “image-B”) is set to 2 θ.

Furthermore, in the image display device, etc. of the present disclosure including the various preferred forms and configurations described hereinabove, it is possible to employ a form in which division is made into at least two images by the optical splitter. If a horizontal direction (an X-axis direction) and a vertical direction (a Y-axis direction) are set with the viewer as a standard, specific examples include a form in which division is made into three images in the horizontal direction by the optical splitter, a form in which division is made into three images in the vertical direction, a form in which an image is divided into three images in the horizontal direction and into three images in the vertical direction in a cross form (since one image including the center light course overlaps, this is a form in which division is made into a total of five images), a form in which an image is divided into two images in the horizontal direction and into two images in the vertical direction, i.e., 2×2=4, and a form in which an image is divided into three images in the horizontal direction and into three images in the vertical direction, i.e., 3×3=9, for example.

Furthermore, in the image display device, etc. of the present disclosure including the various preferred forms and configurations described hereinabove, it is possible to employ a form in which the light collecting element includes a hologram lens, as described above. The hologram lens may have a configuration and a structure that are widely known. The hologram lens may be formed on a surface of a base material. By the light collecting element including a hologram lens, the image display device can be made a semi-transmission (see-through) type, and thereby the exterior can be seen via the light collecting element. In a case where it is not necessary that the image display device be a semi-transmission (see-through) type, the light collecting element may include, for example, an ordinary lens.

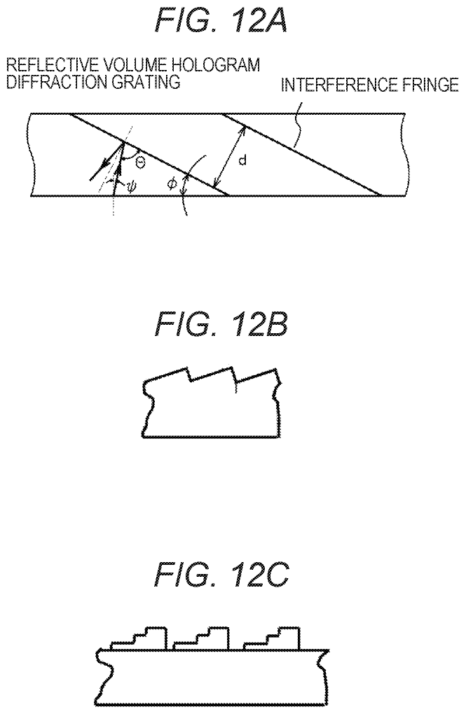

Furthermore, in the image display device, etc. of the present disclosure including the various preferred forms and configurations described hereinabove, it is possible to employ a form in which the optical splitter includes a diffraction grating (a reflective diffraction grating or a transmission diffraction grating). The diffraction grating may have a configuration and a structure that are widely known; examples include a reflective blazed diffraction grating (see FIG. 12B) and a reflective blazed diffraction grating having step shapes (see FIG. 12C), for example; however, the form is not limited to these diffraction gratings. A plurality of images is obtained on the basis of the k-th order diffracted light (provided that k=0, ±1, ±2, . . . ) emitted from the diffraction grating. The diffraction grating is an optical element that creates a diffraction phenomenon by means of a lattice-like pattern; in the lattice pattern, for example, straight-lined concavities and convexities are arranged parallel with a period of a micrometer size; the period, the pattern thickness (the thickness difference between concavity and convexity), etc. of the lattice pattern are selected on the basis of the wavelength region of light emitted from the image forming device, as appropriate. The diffraction grating may be formed on a surface of a base material. Further, a light reflection film including a dielectric multiple-layer film or a metal film may be formed on the light incident surface of the reflective diffraction grating. The diffraction grating may be fabricated by a widely known method.

Alternatively, the optical splitter may include a hologram diffraction grating. That is, the optical splitter may include a transmission volume hologram diffraction grating, or may include a reflective volume hologram diffraction grating.

FIG. 12A illustrates a schematic partial cross-sectional view in which the reflective volume hologram diffraction grating is enlarged. An interference fringe having an inclined angle (a slant angle) φ is formed on the reflective volume hologram diffraction grating. Here, the inclined angle φ indicates an angle between a front surface of the reflective volume hologram diffraction grating and the interference fringe. The interference fringe is formed over a front surface of the reflective volume hologram diffraction grating from the inside thereof. The interference fringe satisfies a Bragg's condition. Here, the Bragg's condition indicates a condition of satisfying Expression (A) described below. In Expression (A), m represents a positive integer, λ represents a wavelength, d represents a pitch of a grating surface (an interval of a virtual flat surface including the interference fringe in a normal line direction), Θ represents a complementary angle of the angle incident on the interference fringe. In addition, a relationship of Θ in a case where light enters the reflective volume hologram diffraction grating at an incident angle ψ, the inclined angle φ, and the incident angle ψ is represented by Expression (B).

m·λ=2·d·sin(Θ) (A)

Θ=90°−(φ+ψ) (B)

If the angle of incidence ψ of light included in an image is fixed, it is necessary to variously change the value of Θ in order to obtain a plurality of images divided by the optical splitter and emitted from the optical splitter. To change the value of Θ, it is sufficient that the value of the angle of inclination φ be changed from Formula (B), and further it is sufficient that the value of the pitch d of the grating surface be changed from Formula (A). In other words, by appropriately selecting the value of the angle of inclination φ and the value of the pitch d of the grating surface, an image incident on the optical splitter including a volume hologram diffraction grating can be divided by the optical splitter, and a plurality of images can be caused to be emitted from the optical splitter. Note that, if an image including parallel light is incident on the optical splitter, also a light beam included in each of images emitted from the optical splitter is parallel light.

It is possible to employ a form in which also a reflective diffraction grating member included in the light reflection member includes a hologram diffraction grating, more specifically, a volume hologram diffraction grating.

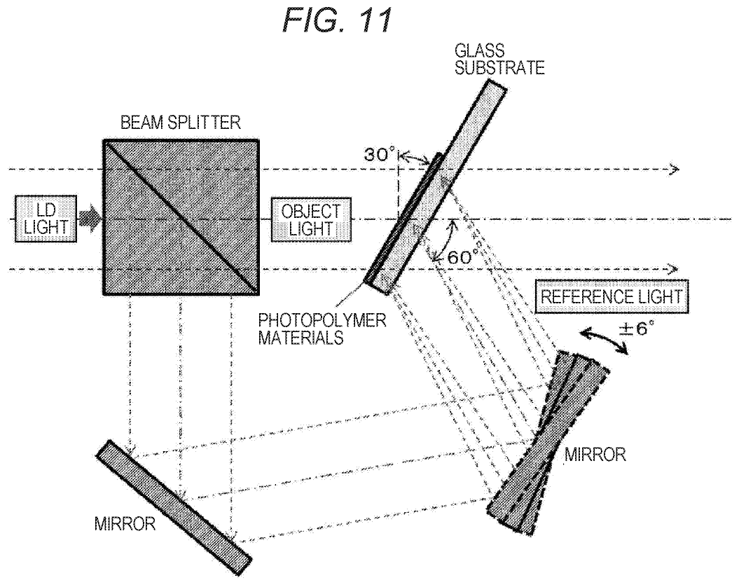

A photopolymer material may be given as a constituent material of the volume hologram diffraction grating. It is sufficient that the constituent material and the basic structure of the volume hologram diffraction grating be the same as the constituent material and the structure of a conventional volume hologram diffraction grating. On the volume hologram diffraction grating, interference fringes are formed from the interior to the surface; it is sufficient that the method for forming relevant interference fringes themselves be the same as a conventional formation method. Specifically, it is sufficient that, as shown in FIG. 11, for example, a member (for example, a photopolymer material) included in the volume hologram diffraction grating be irradiated with object light from a first prescribed direction on one side and simultaneously the member included in the volume hologram diffraction grating be irradiated with reference light from a second prescribed direction on another side, and interference fringes formed by the object light and the reference light be recorded in the volume hologram diffraction grating. In the example shown in FIG. 11, a mirror that applies reference light to the photopolymer material is tilted 60 degrees and (60±6 degrees), and reference light is applied to the photopolymer material three times in total. In the volume hologram diffraction grating thus obtained, the injected image can be divided into three images. A desired pitch of interference fringes on the surface of the volume hologram diffraction grating and a desired angle of inclination (angle of slanting) of interference fringes can be obtained by appropriately selecting the first prescribed direction, the second prescribed direction, and the wavelengths of object light and reference light. The angle of inclination of interference fringes means the angle between the surface of the volume hologram diffraction grating and the interference fringes. In a case where the volume hologram diffraction grating includes a stacked structure of P volume hologram diffraction grating layers, it is sufficient that the stacking of such volume hologram diffraction grating layers be performed by a method in which P volume hologram diffraction grating layers are separately fabricated and then the P volume hologram diffraction grating layers are stacked (adhered) using, for example, an ultraviolet curable adhesive. Further, P volume hologram diffraction grating layers may be fabricated by a method in which one volume hologram diffraction grating layer is fabricated using a photopolymer material having tackiness and then photopolymer materials having tackiness are sequentially stuck thereon to fabricate volume hologram diffraction grating layers. Such a volume hologram diffraction grating is a refractive index modulation type. As necessary, monomers in the photopolymer materials that are not polymerized but left during the irradiation of the fabricated volume hologram diffraction grating layers with object light and reference light may be polymerized and fixated by irradiating the volume hologram diffraction grating layers with energy rays. Further, heat treatment may be performed for stabilization, as necessary.

Furthermore, in the image display device of the present disclosure including the various preferred forms and configurations described hereinabove, it is possible to employ a form in which a position display means is installed; in this case, it is possible to employ a form in which the position display means includes a retroreflection marker.

Furthermore, in the image display device of the present disclosure including the various preferred forms and configurations described hereinabove, it is possible to employ a form in which the image forming device is placed more on the front side than the viewer. Note that, as long as the image forming device is placed more on the front side than the viewer, the image forming device may be located in a place higher than the head of the viewer, may be located at the same level as the head of the viewer, may be located in a place lower than the head of the viewer, may be located facing the viewer, or may be located obliquely with respect to the viewer, depending on the specifications of the optical splitter and the light collecting element.

Furthermore, it is possible to employ a form in which any of the image display device, etc. of the present disclosure including the various preferred forms and configurations described hereinabove is mounted on the head of the viewer. That is, it is possible to employ a form in which each of the image display device, etc. of the present disclosure is a head-mounted display (HMD), more specifically, a retinal projection HMD based on the Maxwellian view.

In a case of forming the base material with transparent plastic materials, examples of plastic materials include polyethylene terephthalate, polyethylene naphthalate, polycarbonate, cellulose esters such as cellulose acetate, fluoropolymers such as a copolymer of polyvinylidene fluoride or polytetrafluoroethylene and hexafluoropropylene, polyethers such as polyoxymethylene, polyolefins such as polyacetal, polystyrene, polyethylene, polypropylene, and a methylpentene polymer, polyimides such as polyamide-imide and polyetherimide, polyamide, polyethersulfone, polyphenylene sulfide, polyvinylidene fluoride, tetraacetyl cellulose, brominated phenoxy, polyarylate, polysulfone, and the like. In a case of forming the base material with glass, examples of glass include transparent glass, such as soda-lime glass or white sheet glass. A hard coat layer including an organic/inorganic mixed layer and/or an antireflection film containing a fluorine-based resin may be formed on the outer surface of the base material. The support member may include a framework-like member containing a metal, an alloy, or a plastic material, and may include a frame described later.

In the image display device of the present disclosure having various preferred aspects and configurations described hereinabove, it is possible to set an aspect in which the image forming device includes a plurality of pixels arranged in a two-dimensional matrix. Such a configuration of the image forming device, for convenience, will be referred to as an “image forming device of a first configuration”.

For example, examples of the image forming device of the first configuration are capable of including an image forming device configured of a reflective spatial light modulation device and a light source; an image forming device configured of a transmissive spatial light modulation device and a light source; and an image forming device configured of a light emitting element such as an organic electro luminescence (EL), an inorganic EL, a light emitting diode (LED), and a semiconductor laser element, and among them, the image forming device configured of the organic EL light-emitting element (organic EL display device), or the image forming device configured of the reflective spatial light modulation device and the light source is preferable. Examples of the spatial light modulation device are capable of including a light valve, for example, a transmissive or reflective liquid crystal display device such as liquid crystal on silicon (LCOS), and a digital micro mirror device (DMD), and examples of the light source are capable of including a light emitting element. Further, it is possible to set a configuration in which the reflective spatial light modulation device includes a polarization beam splitter which reflects a part of light from the liquid crystal display device and the light source and guides the light to the liquid crystal display device, allows a part of light reflected by the liquid crystal display device to pass therethrough, and guides the light to an optical splitter. Examples of the light emitting element configuring the light source are capable of including a red light emitting element, a green light emitting element, a blue light emitting element, and a white light emitting element. Alternatively, red light, green light, and blue light exiting from the red light emitting element, the green light emitting element, and the blue light emitting element are mixed or subjected to brightness homogenization by using a light pipe, and thus, white light may be obtained. For example, a semiconductor laser element, a solid laser, or an LED can be exemplified as the light emitting element. It is sufficient that the number of pixels be determined on the basis of the specification to be required in the image display device, and 320×240, 432×240, 640×480, 1024×768, 1920×1080, and the like can be exemplified as a specific value of the number of pixels. In the image forming device of the first configuration, it is possible to employ a form in which a diaphragm is placed in a position of the front focus (the focus on the image forming device side) of a lens system (described later); the diaphragm falls under an image emission section from which an image is emitted from the image forming device.

Alternatively, in the image display device of the display device according to the present disclosure having preferred aspects and configurations described hereinabove, it is possible to set an aspect in which the image forming device includes the light source, and a scanning means scanning light exiting from the light source to form an image. Such an image forming device, for convenience, will be referred to as an “image forming device of a second configuration”.

Examples of the light source in the image forming device of the second configuration are capable of including a light emitting element, and specifically, are capable of including a red light emitting element, a green light emitting element, a blue light emitting element, and a white light emitting element, or red light, green light, and blue light exiting from the red light emitting element, the green light emitting element, and the blue light emitting element are mixed or subjected to brightness homogenization by using a light pipe, and thus, white light may be obtained. For example, a semiconductor laser element, a solid laser, or an LED can be exemplified as the light emitting element. It is sufficient that the number of pixels (virtual pixels) in the image forming device of the second configuration be determined on the basis of the specification to be required in the image display device, and 320×240, 432×240, 640×480, 1024×768, 1920×1080, and the like can be exemplified as a specific value of the number of pixels (virtual pixels). In addition, in a case where color image display is performed, and the light source is configured of the red light emitting element, the green light emitting element, and the blue light emitting element, for example, it is preferable to perform color synthesis by using a cross prism. Examples of the scanning means are capable of including a micro electro mechanical systems (MEMS) mirror including a micro mirror which is capable of performing horizontal scanning and perpendicular scanning with respect to light exiting from the light source, for example, rotating the light in a two-dimensional direction, or a Galvano mirror. In the image forming device of the second configuration, it is possible to employ a form in which a MEMS mirror or a galvanometer mirror is placed in a position of the front focus (the focus on the image forming device side) of a lens system (described later); the MEMS mirror and the galvanometer mirror fall under an image emission section from which an image is emitted from the image forming device.

In the image forming device of the first configuration or the image forming device of the second configuration, light that is a plurality of rays of parallel light formed by a lens system (an optical system that converts emission light to parallel light) is caused to be incident on the optical splitter; by thus forming parallel light, an image can be divided into a plurality of images by the optical splitter, and images formed on the retina of the viewer can be made the same image. To generate parallel light, specifically, it is sufficient that, for example, a light emission section of the image forming device be caused to be located in a place (position) of the focal distance in a lens system, as described above. Examples of the lens system are capable of including an optical system having positive optical power as a whole in which a convex lens, a concave lens, a free-form surface prism, or a hologram lens is provided singly or two or more of them are combined. Between the lens system and the optical splitter, a light blocking section having an aperture section may be placed in the vicinity of the lens system so that undesired light is not emitted from the lens system or is not incident on the optical splitter.

In the image display device, etc. of the present disclosure, it is possible to employ a form in which a support member or a base material is installed on a frame. Alternatively, it is also possible to employ a form in which a frame serves also as a support member. Alternatively, it is also possible to employ a form in which a support member or a base material is installed on a frame in a freely attachable and detachable manner by, for example, using a magnet or using a hook-shaped member. The frame includes a front section placed on the front side of the viewer, two temple sections installed in a freely rotationally movable manner at both ends of the front section via hinges, and nose pads. An end cover section is installed at a tip section of each temple section. An assembled body of the frame (including a rim section) and the nose pads has substantially the same structure as ordinary eyeglasses. Also the nose pad may have a configuration and a structure that are widely known. Further, it is also possible to employ a configuration in which a front section and two temple sections are integrated. That is, if the entirety of any of the image display device, etc. of the present disclosure is seen, the frame has substantially the same structure as ordinary eyeglasses on the whole. The material contained in the frame including nose pads may be the same material as the material contained in ordinary eyeglasses, such as a metal, an alloy, or a plastic, or a combination of these.

The image display device to be mounted on the viewer has a very simple structure, and has no driving section and therefore does not need a battery or the like for driving; thus, the size and weight of the image display device can be reduced easily. Unlike conventional HMDs, the image forming device is not mounted on the head of the viewer. The image forming device is provided in a facility or the like in the outside, or is mounted as a wearable device on a wrist or the like of the viewer. The following are given as examples in which the image forming device is provided in a facility or the like in the outside.

(A) An example in which an image forming device for a passenger is installed on the back surface of the back (backrest) of a seat of a vehicle or an airplane

(B) An example in which an image forming device for a spectator is installed on the back surface of the back (backrest) of a seat of a theater or the like

(C) An example in which an image forming device for a driver or the like is installed in a vehicle, an airplane, an automobile, a motorcycle, a bicycle, or the like

(D) An example of being used as a substitute for a monitor used in a personal computer

(E) An example of being used as a substitute for a display or a touch panel used in an automated teller machine in a financial institution

(F) An example of being used as a substitute for a display or a touch panel used in a shop or an office

(G) An example of enlarging and displaying a screen of a mobile phone

(H) An example of being used as a substitute for a display plate or the like used in an art museum, an amusement park, or the like

(I) An example in which an image forming device for a customer is installed on a table of a teahouse, a cafe, or the like

In the display device of the present disclosure having various preferred aspects and configurations described hereinabove (hereinafter, such devices may be collectively referred to as the “display device or the like of the present disclosure”), it is possible to set an aspect in which a signal for displaying an image on the image display device (a signal for forming a virtual image in the image display device) is received from the outside (outside the display device). In such an aspect, information or data regarding the image displayed on the image display device, for example, is recorded, managed, and stored in a so-called cloud computer or a server, and the image forming device includes a communication unit, for example, a telephone line, an optical line, a mobile phone or a smart phone, or combines the image forming device with the communication unit, and thus, the delivery and the exchange of various information items or data items between the cloud computer or the server and the image forming device can be performed, and a signal based on various information items or data items, that is, the signal for displaying an image on the image display device can be received. Alternatively, it is possible to set an aspect in which the signal for displaying an image on the image display device is stored in the image forming device. The image displayed on the image display device includes various information items or various data items. The image forming device as a wearable device may be an aspect having a camera (an imaging device), an image imaged by the camera may be transmitted to the cloud computer or the server through the communication unit, various information items or data items corresponding to the image imaged by the camera may be searched in the cloud computer or the server, various information items or data items, which have been searched, may be transmitted to the image forming device through the communication unit, and various information items or data items, which have been searched, may be displayed on the image display device as an image.

The display device or the like according to the present disclosure including the various aspects and configurations described hereinabove, for example, can be used for displaying various information items or the like in various sites on the internet, and displaying various descriptions, symbols, signs, marks, emblems, designs, and the like at the time of driving, manipulating, maintaining, disassembling, and the like an observation target of various devices or the like; displaying various descriptions, symbols, signs, marks, emblems, designs, and the like relevant to the observation target such as a person or articles; displaying a moving image or a still image; displaying the subtitle of a motion picture or the like; displaying the descriptive text and the closed caption relevant to a video synchronized with the video; or displaying various descriptions relevant to the observation target in the play or the kabuki, the Japanese traditional masked dance-drama, the comic drama, the opera, the concert, the ballet, various theatrical plays, the amusement park, the museum, the sightseeing spot, the resort, the tourist information, and the like, and the descriptive text or the like for describing the contents or the progress status, the background, and the like, and can be used for displaying the closed caption. It is sufficient that, in the play or the kabuki, the Japanese traditional masked dance-drama, the comic drama, the opera, the concert, the ballet, various theatrical plays, the amusement park, the museum, the sightseeing spot, the resort, the tourist information, and the like, a character as an image relevant to the observation target be displayed on the image display device at a suitable timing. Specifically, for example, an image control signal is transmitted on the image display device according to the manipulation of the operator or under the control of a computer or the like, on the basis of a predetermined schedule and time allocation, according to the progress status of the motion picture or the like or according to the progress status of the play or the like, and the image is displayed on the image display device. In addition, various descriptions relevant to the observation target of various devices, the person or the articles, and the like are displayed, but the observation target of various devices, the person or the articles, and the like is shot (imaged) by the camera, and the shot (imaged) contents are analyzed in the image forming device, and thus, various descriptions relevant to the observation target of various devices, the person or the articles, and the like, prepared in advance, can be displayed on the image display device.

### EXAMPLE 1

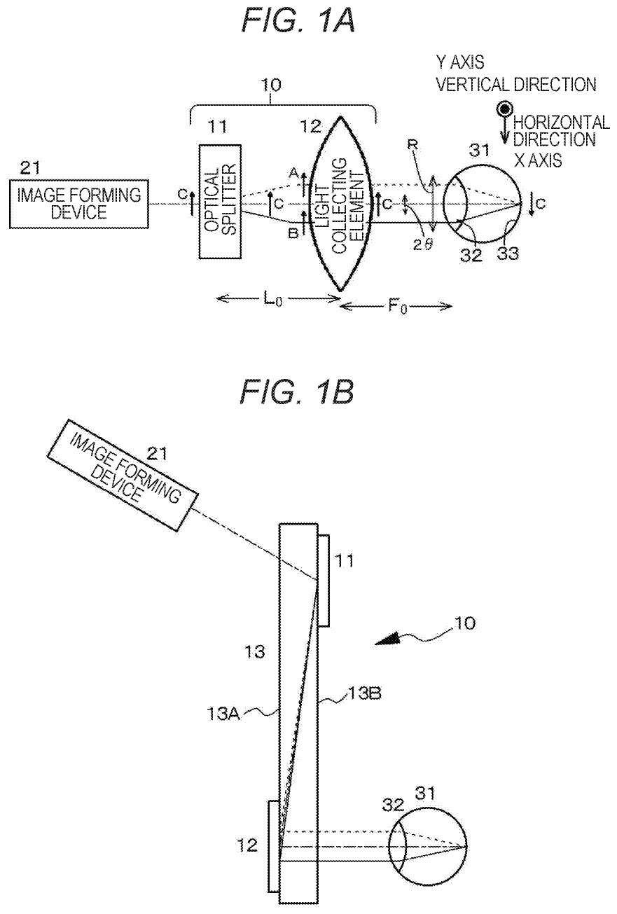

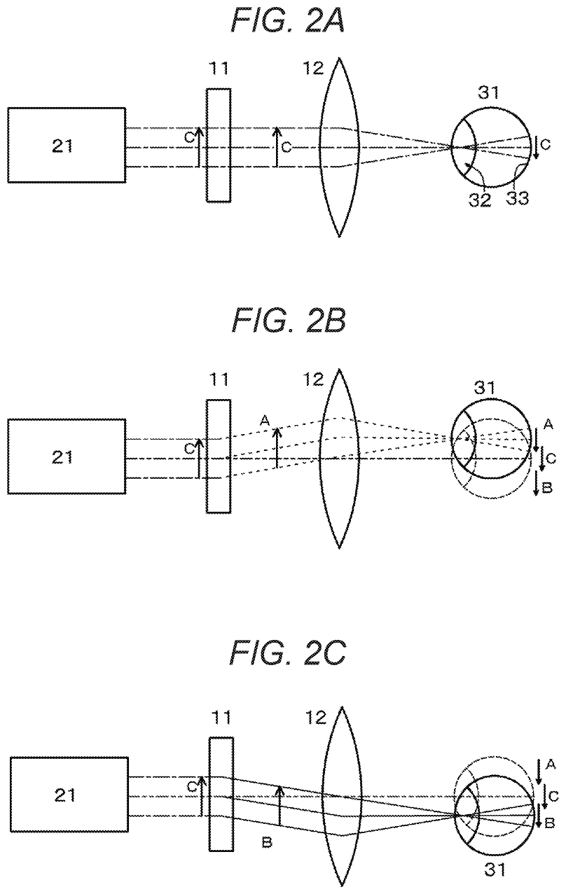

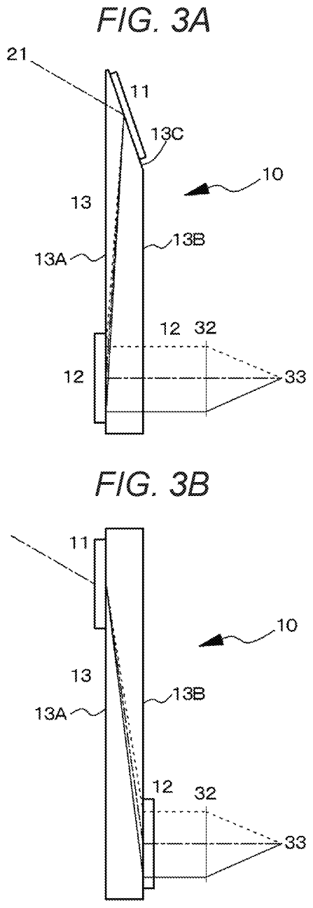

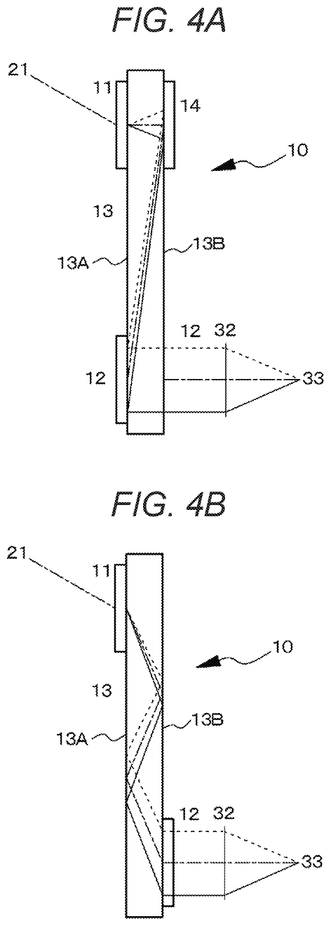

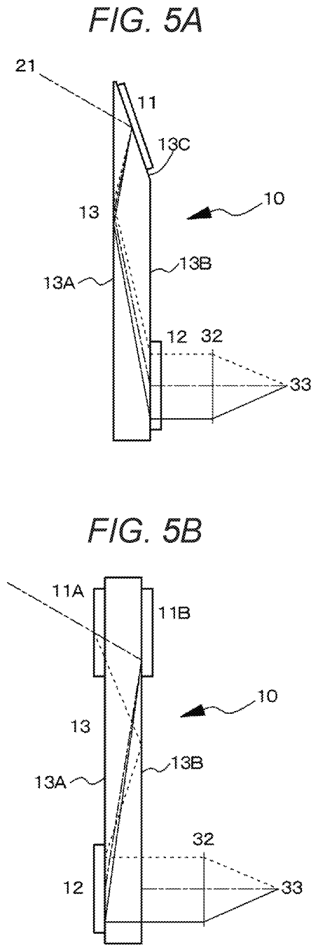

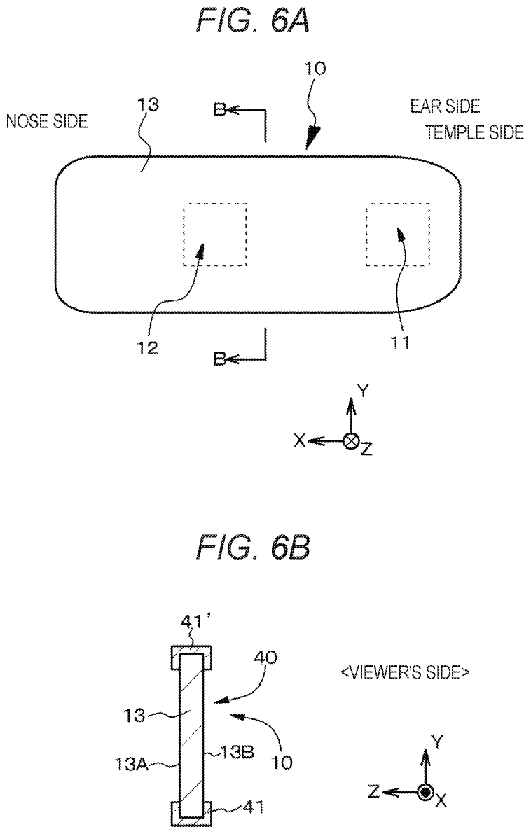

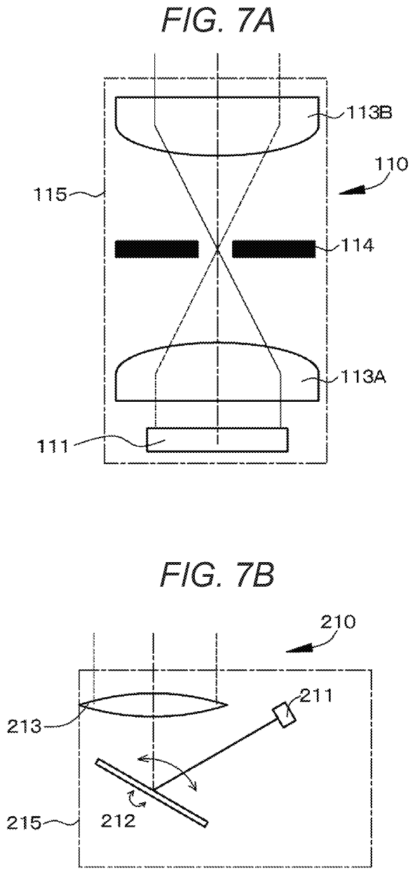

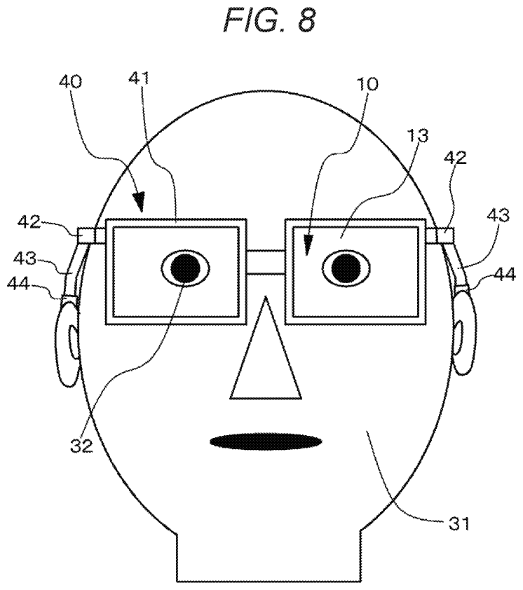

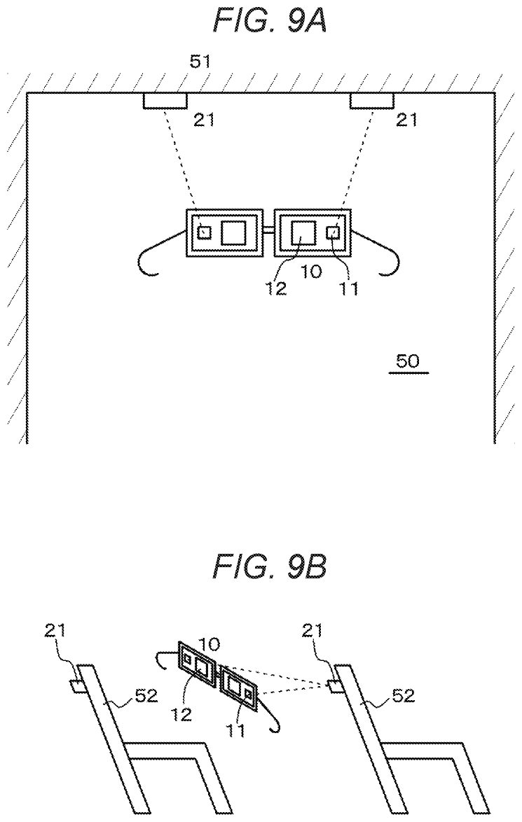

Example 1 relates to the image display devices according to the first aspect to the third aspect of the present disclosure and the display device of the present disclosure. Conceptual diagrams of an image display device and a display device of Example 1 are shown in FIG. 1A, FIG. 2A, FIG. 2B, and FIG. 2C, and a schematic cross-sectional view of the image display device of Example 1 is shown in FIG. 1B. Further, a schematic diagram of the image display device of Example 1 as seen from the front side is shown in FIG. 6A, a schematic cross-sectional view of the image display device of Example 1 taken in the XZ plane is shown in FIG. 6B, a conceptual diagram of an image forming device of the first configuration is shown in FIG. 7A, and a conceptual diagram of an image forming device of the second configuration is shown in FIG. 7B. Furthermore, a schematic diagram of a frame, etc. including the image display device of Example 1 as seen from the front side is shown in FIG. 8, a state where a display device of Example 1 is being used in a room is shown in FIG. 9A, and a schematic diagram in which an image forming device is provided on the back surface of the back (backrest) of each of seats is shown in FIG. 9B. Note that, although FIG. 1B, FIG. 3A, FIG. 3B, FIG. 4A, FIG. 4B, FIG. 5A, and FIG. 5B are schematic cross-sectional views of image display devices and normally should be marked with hatching lines, hatching lines are omitted for simplification of the drawings.

An image display device 10 of Example 1 includes:

an optical splitter 11 to which an image emitted from an image forming device 21 placed in an outside (outside the image display device) is injected and that is configured to divide the image into a plurality of images; and

a light collecting element 12 configured to collect (to causes an image to converge), on a pupil 32 of a viewer 31, a plurality of images divided by the optical splitter 11 and emitted from the optical splitter 11.

Further, if a focal distance of the light collecting element 12 is denoted by F₀ (unit: mm) and an optical distance from the optical splitter 11 to the light collecting element 12 is by L₀ (unit: mm),

L₀=F₀±10

is satisfied. The focal distance F₀ is equal to, for example, the optical distance from the light collecting element 12 to the pupil 32 of the viewer 31 of the center light course. That is, the pupil 32 of the viewer 31 is located at a focus of the light collecting element 12. Alternatively, if an extension line of the center line of the pupil is taken as a Z-axis, a straight line connecting the turning centers of the left and right eyeballs is as an X-axis, and an axis orthogonal to the X-axis and the Z-axis is as a Y-axis, the optical splitter 11 and the light collecting element 12 are provided in an imaginary plane parallel to the XY plane. Alternatively, the optical splitter 11 is provided on the ear side of the viewer 31, and the light collecting element 12 is provided on the nose side of the viewer 31.

Note that the image display device according to the first aspect of the present disclosure and the image display device according to the second aspect of the present disclosure may be combined, the image display device according to the first aspect of the present disclosure and the image display device according to the third aspect of the present disclosure may be combined, the image display device according to the second aspect of the present disclosure and the image display device according to the third aspect of the present disclosure may be combined, and the image display device according to the first aspect of the present disclosure, the image display device according to the second aspect of the present disclosure, and the image display device according to the third aspect of the present disclosure may be combined.

Further, a display device of Example 1 includes the image forming device 21 and an image display device, and the image display device includes the image display device 10 of Example 1. Then, the image display device 10 of Example 1 is a head-mounted display (HMD) to be mounted on the head of the viewer 31, specifically, a retinal projection HMD based on the Maxwellian view.

In the image display device 10 of Example 1, a light beam included in an image incident on the optical splitter 11 is parallel light, and also a light beam included in each of a plurality of images emitted from the optical splitter 11 is parallel light. Further, a plurality of images divided by the optical splitter 11 and formed on the retina 33 of the viewer 31 is the same image. Furthermore, division is made into at least two images by the optical splitter 11. In FIG. 1A, FIG. 2A, FIG. 2B, and FIG. 2C, an image including parallel light emitted from the image forming device 21 is shown by arrow “C”. The image shown by arrow “C” incident on the optical splitter 11 is, when emitted from the optical splitter 11, divided in a plurality of images, for example three images, namely, the images shown by arrows “A”, “C”, and “B” (see FIG. 1A). Specifically, in Example 1, if a horizontal direction (the X-axis direction) and a vertical direction (the Y-axis direction) are set with the viewer 31 as a standard, division is made into three images in the horizontal direction. The image shown by arrow “C” is an image (see FIG. 2A) including a light flux including the center light course (shown by the alternate long and short dash line). The angle between the light flux located at the center (referred to as “center light flux-A”, shown by the dotted line, see FIG. 2B) of the image located most on the outside (the image shown by arrow “A”) among the images divided by the optical splitter 11 and the light flux located at the center (referred to as “center light flux-B”, shown by the thin line, see FIG. 2C) of the image located most on the outside symmetrically to the image shown by arrow “A” with the center light course as a symmetry axis (the image shown by arrow “B”) is defined as 2 θ. In a case where the optical splitter 11 includes a reflective diffraction grating, the image shown by arrow “A”, the image shown by arrow “C”, and the image shown arrow “B” incident on the pupil 32 of the viewer 31 are images including rays of parallel light including the +1 st order diffracted light, the 0-th order diffracted light, and the -1st order diffracted light, for example. Further, in a case where the optical splitter 11 includes a reflective volume hologram diffraction grating, the images are images obtained by appropriately selecting three kinds of value of the angle of inclination φ and three kinds of value of the pitch d of the grating surface. Note that, in the illustrated example, each of the +1st order diffracted light and the -1st order diffracted light that are emitted from the optical splitter 11 and are incident on the light collecting element 12 becomes light substantially parallel to the 0-th order light when emitted from the light collecting element 12, is converged (collected) by the pupil 32 of the viewer 31, and is formed as one image as a whole on the retina 33 of the viewer 31.

In Example 1, L₀=F₀=20 mm. Further, 2 θ=13.6 degrees.

FIG. 2A shows a state where a light flux including the center light course is incident on the center of the pupil 32 of the viewer 31. In this state, the viewer 31 recognizes mainly the image shown by arrow “C” as an image. FIG. 2B shows a state where the viewer 31 has moved a little relative to the light collecting element 12 on the right side in the horizontal direction. Further, FIG. 2C shows a state where the viewer 31 has moved a little relative to the light collecting element 12 on the left side in the horizontal direction. In these states, the viewer 31 recognizes mainly the image shown by arrow “A” or arrow “B” as an image. Thus, even if the viewer 31 moves in the horizontal direction, an image emitted from the image forming device can continue to be seen appropriately. However, in a case where division is not made by the optical splitter 11 into three images, namely, the images shown by arrows “A”, “C”, and “B”, if the pupil 32 of the viewer 31 moves relative to the light collecting element 12, the viewer 31 recognizes the image shown by arrow “C” as an image as shown in FIG. 2B or FIG. 2C, but this image can hardly be said to be an optimum image, and an image cannot be recognized depending on circumstances.

In the image display device 10 of Example 1 shown in FIG. 1B, FIG. 6A, and FIG. 6B, if a surface on the image incident side of a base material 13 is defined as a first surface 13A and a surface facing the first surface 13A is as a second surface 13B, the optical splitter 11 is provided on the second surface 13B, and the light collecting element 12 is provided on the first surface 13A. Here, the second surface 13B falls under a first XY plane, and the first surface 13A falls under a second XY plane. The distance between the first XY plane and the second XY plane (the thickness of the substrate 13) is, for example, not more than 30 mm, and is, for example, 1 mm to 30 mm. A plurality of images divided by the optical splitter 11 is directly incident on the light collecting element 12. The space located between the optical splitter 11 and the light collecting element 12 may be occupied by air, but is, in the illustrated example, occupied by the base material 13 (for example, a plastic material or glass). The optical splitter 11 includes a reflective diffraction grating or a reflective hologram diffraction grating (specifically, a reflective volume hologram diffraction grating), or a transmission diffraction grating or a transmission hologram diffraction grating (specifically, a transmission volume hologram diffraction grating). In Example 1, more specifically, the optical splitter 11 includes a reflective diffraction grating or a reflective volume hologram diffraction grating. Further, the light collecting element 12 includes a hologram lens. The image display device 10 is a semi-transmission (see-through) type, and the exterior can be seen via the light collecting element 12. The amount of displacement on the pupil 32 of the viewer 31 between a plurality of images divided by the optical splitter 11 is not less than 2 mm and not more than 7 mm. Alternatively,

2(mm)≤F₀·tan(θ)≤7 (mm) (1)

is satisfied.

Since

F₀=20 mm,

and

2 θ=13.6 degrees,

F₀·tan(θ)=2.4 mm. The diameter of the pupil of a human being shown by “R” in FIG. 1A is 2 mm in a bright environment and 7 mm in a dark environment. Therefore, an image (a light flux) can be surely caused to be incident on the pupil 32 of the viewer 31 by setting the amount of displacement on the pupil 32 of the viewer 31 between a plurality of images divided by the optical splitter 11 to not less than 2 mm and not more than 7 mm or by satisfying Formula (1).

In Example 1, as shown in the conceptual diagram of FIG. 7A, an image forming device 110 is an image forming device of the first configuration, and has a plurality of pixels arranged in a two-dimensional matrix form. Specifically, the image forming device 110 includes an organic EL display device 111. An image emitted from the organic EL display device 111 passes through a first convex lens 113A included in a lens system, further passes through a second convex lens 113B included in the lens system to become parallel light, and goes toward the optical splitter 11. The front focus f_{2F} of the second convex lens 113B is located at the back focus f_{1B} of the first convex lens 113A. Further, a diaphragm 114 is placed at the position of the back focus fiB of the first convex lens 113A (the front focus f2F of the second convex lens 113B). The diaphragm 114 falls under an image emission section. The entirety of the image forming device 110 is housed in a casing 115. The organic EL display device 111 includes a plurality of (for example, 640×480) pixels (organic EL elements) arranged in a two-dimensional matrix form.

Alternatively, as shown in the conceptual diagram of FIG. 7B, an image forming device 210 is an image forming device of the second configuration, and includes a light source 211, a scanning means 212 that scans parallel light emitted from the light source 211, and a lens system 213 that converts light emitted from the light source 211 to parallel light. The entirety of the image forming device 210 is housed in a casing 215; an aperture section (not illustrated) is provided in the relevant casing 215, and light is emitted from the lens system 213 to the optical splitter 11 via the aperture section. The light source 211 includes, for example, a semiconductor laser element. Light emitted from the light source 211 is converted to parallel light by a not-illustrated lens, is subjected to horizontal scanning and vertical scanning by the scanning means 212 that includes a MEMS mirror in which a micromirror is freely rotatable in two-dimensional directions to allow incident parallel light to be scanned two-dimensionally, and is made into a kind of two-dimensional image; thus, virtual pixels (the number of pixels may be, for example, the same as that of the image forming device 110) are generated. Then, light sent from the virtual pixels (the scanning means 212 falling under the image emission section) passes through the lens system 213 having positive optical power, and a light flux converted to parallel light is incident on the optical splitter 11.

As shown in FIG. 8, which is a schematic diagram of a frame 40, etc. including the image display device 10 as seen from the front side, the frame 40 includes a front section 41 placed on the front side of the viewer 31, two temple sections 43 installed in a freely rotationally movable manner at both ends of the front section 41 via hinges 42, and an end cover section (also called a temple tip, an earmuff, or an ear pad) 44 installed at a tip section of each temple section 43. Further, nose pads (not illustrated) are installed. That is, an assembled body of the frame 40 and the nose pads basically has substantially the same structure as ordinary eyeglasses. The frame 40 contains a metal or a plastic. A base material 13 may be fitted into a rim section 41′ provided in the front section (see FIG. 6B). Note that the optical splitter 11 and the light collecting element 12 may be installed on an appropriate support member and the support member may be fitted into the rim section 41′.

A use example of the display device of Example 1 is shown in FIG. 9A; FIG. 9A is a schematic diagram of a state where the display device of Example 1 is being used in a room. Image forming devices 21 are provided on a wall surface 51 of a room 50. If a viewer stands in a prescribed position of the room 50, an image sent from the image forming device 21 arrives at the optical splitter 11 included in the image display device 10, and the viewer can see this image via the light collecting element 12.

Alternatively, another use example of the display device of Example 1 is shown in FIG. 9B, which is a schematic diagram of a state where the image forming device 21 included in the display device of Example 1 is provided on the back surface of the back (backrest) of each of seats 52 and is being used. If a viewer takes a seat 52 on the rear side, an image is emitted from the image forming device 21 provided on the back surface of the back of a seat 52 on the front side toward the image display device 10 mounted on the viewer and arrives at the optical splitter 11 included in the image display device 10, and the viewer can see this image via the light collecting element 12. More specifically, an example in which an image forming device for a passenger is installed on the back surface of the back (backrest) of a seat of a vehicle or an airplane and an example in which an image forming device for a spectator is installed on the back surface of the back (backrest) of a seat of a theater or the like may be given.

As hereinabove, in the image display device of the present disclosure or the image display device included in the display device of the present disclosure, an optical splitter and a light collecting element are provided, and a plurality of images divided by the optical splitter and emitted from the optical splitter is collected (converged) on the pupil of a viewer. Therefore, the viewer can surely recognize at least one image among the plurality of images; even if the plurality of images incident on the pupil of the viewer overlap, the images can be recognized as one image by the viewer because the relationship between F₀ and L₀ has been prescribed. Therefore, even if the position of the light collecting element and the position of the pupil of the viewer change relatively, at least one of the plurality of images can be surely caused to be collected (converged) on the pupil of the viewer; thus, the possibility that an image (a light flux) will deviate from the pupil of the viewer can be made as low as possible, and the viewer can continue to view the image. In addition, since the relationship between F₀ and L₀ has been prescribed, alternatively since the optical splitter and the light collecting element are provided in an imaginary plane parallel to the XY plane, or alternatively since the optical splitter is provided on the ear side of the viewer and the light collecting element is provided on the nose side of the viewer, the size and weight of the display device or the image display device included in the relevant display device can be reduced, and the difficulty of providing an optical splitter between an image forming device and an eyepiece like in conventional technology can be solved.

Although in the example shown in FIG. 1B the optical splitter 11 is provided on the second surface 13B and the light collecting element 12 is provided on the first surface, as shown in FIG. 3A, an oblique surface 13C may be formed on the second surface 13B of the base material 13, and the optical splitter 11 including a reflective diffraction grating or a reflective volume hologram diffraction grating may be provided on the oblique surface 13C. That is, the optical splitter 11 is provided in a first XY plane (the second surface 13C), the light collecting element 12 is provided in a second XY plane (the first surface 13A), and the first XY plane 13C is inclined with respect to the second XY plane 13A. Further, as shown in FIG. 3B, the optical splitter 11 including a transmission diffraction grating or a transmission volume hologram diffraction grating may be provided on the first surface 13A (a first XY plane), and the light collecting element 12 including a hologram lens may be provided on the second surface (a second XY plane).

### EXAMPLE 2

Example 2 is a modification of Example 1. Schematic cross-sectional views of image display devices of Example 2 and modification examples thereof are shown in FIG. 4A, FIG. 4B, FIG. 5A, and FIG. 5B.

In the image display device 10 of Example 2, a plurality of images divided by the optical splitter 11 is reflected once or more, and is incident on the light collecting element 12. Specifically, the optical splitter 11 includes a transmission diffraction grating or a transmission hologram diffraction grating, or a reflective diffraction grating or a reflective hologram diffraction grating, the light collecting element 12 includes a hologram lens, and a light reflection member that reflects, toward the light collecting element 12, light emitted from the optical splitter 11 is further provided.

In the example shown in FIG. 4A, the optical splitter 11 includes a transmission diffraction grating or a transmission volume hologram diffraction grating, the light collecting element 12 includes a hologram lens, and a light reflection member 14 that reflects, toward the light collecting element 12, light emitted from the optical splitter 11 includes a reflective diffraction grating member (more specifically, a reflective volume hologram diffraction grating). The space located between the optical splitter 11, the light reflection member 14, and the light collecting element 12 may be occupied by air, but is, in the example shown in FIG. 4A, occupied by a base material 13 (for example, a plastic material or glass). The optical splitter 11 and the light collecting element 12 are provided on the first surface 13A (an imaginary plane parallel to the XY plane) of the base material 13, and the light reflection member 14 is provided on the second surface 13B of the base material 13. An image including parallel light sent from the image forming device 21 is incident on the optical splitter 11, is divided into a plurality of images each including parallel light, is incident on the light reflection member 14, is reflected by the light reflection member 14, is incident on the light collecting element 12, is emitted from the light collecting element 12, and is collected on the pupil 32 of the viewer 31.

In the example shown in FIG. 4B, the optical splitter 11 includes a transmission diffraction grating or a transmission volume hologram diffraction grating, the light collecting element 12 includes a hologram lens, and a light reflection member that reflects, toward the light collecting element 12, light emitted from the optical splitter 11 includes a base material 13. The optical splitter 11 is provided on the first surface 13A (a first XY plane) of the base material 13, and the light collecting element 12 is provided on the second surface 13B (a second XY plane) of the base material 13. An image including parallel light sent from the image forming device 21 is incident on the optical splitter 11, is divided into a plurality of images each including parallel light, propagates through the base material 13, is totally reflected in the base material 13 twice, is incident on the light collecting element 12, is emitted from the light collecting element 12, and is collected on the pupil 32 of the viewer 31.

In the example shown in FIG. 5A, an oblique surface 13C (a first XY plane) is formed on the second surface 13B of the base material 13, and the optical splitter 11 including a reflective diffraction grating or a reflective volume hologram diffraction grating is provided on the oblique surface 13C. A light reflection member that reflects, toward the light collecting element 12, light emitted from the optical splitter 11 includes the base material 13. The light collecting element 12 is provided on the first surface 13A (a second XY plane) of the base material 13. An image including parallel light sent from the image forming device 21 is incident on the optical splitter 11, is divided into a plurality of images each including parallel light, propagates through the base material 13, is totally reflected in the base material 13 once, is incident on the light collecting element 12, is emitted from the light collecting element 12, and is collected on the pupil 32 of the viewer 31. Note that the optical splitter 11 including a reflective diffraction grating or a reflective volume hologram diffraction grating may be provided on a flat second surface 13B (a first XY plane).

In the example shown in FIG. 5B, two optical splitters 11A and 11B are provided on the first surface 13A (a first XY plane) and the second surface 13B (another first XY plane) of the base material 13. Specifically, a first optical splitter 11A including a transmission diffraction grating or a transmission volume hologram diffraction grating is provided on the first surface 13A (a first XY plane) of the base material 13, and a second optical splitter 11B including a reflective diffraction grating or a reflective volume hologram diffraction grating is provided on the second surface 13B (another first XY plane) of the base material 13. The light collecting element 12 provided on the first surface 13A (the first XY plane) of the base material 13 includes a hologram lens, and a light reflection member that reflects, toward the light collecting element 12, light emitted from the optical splitter 11 includes the base material 13. An image including parallel light sent from the image forming device 21 is incident on the first optical splitter 11A, and is divided into a plurality of images (two images in the example shown in FIG. 5B) each including parallel light; part (one image in the example shown in FIG. 5B) of the plurality of images propagates through the base material 13, is totally reflected at the second surface 13B of the base material 13, is incident on the light collecting element 12, is emitted from the light collecting element 12, and is collected on the pupil 32 of the viewer 31. Further, the rest of the plurality of images (the other one image in the example shown in FIG. 5B) is divided into a plurality of images (two images in the example shown in FIG. 5B) each including parallel light and reflected by the second optical splitter 11B, or is reflected by the second optical splitter 11B in a case of one image, is incident on the light collecting element 12, is emitted from the light collecting element 12, and is collected on the pupil 32 of the viewer 31.

Except the above respects, the configuration and the structure of the image display device or the display device of Example 2 may be similar to the configuration and the structure of the image display device or the display device of Example 1, and hence a detailed description is omitted.

### EXAMPLE 3

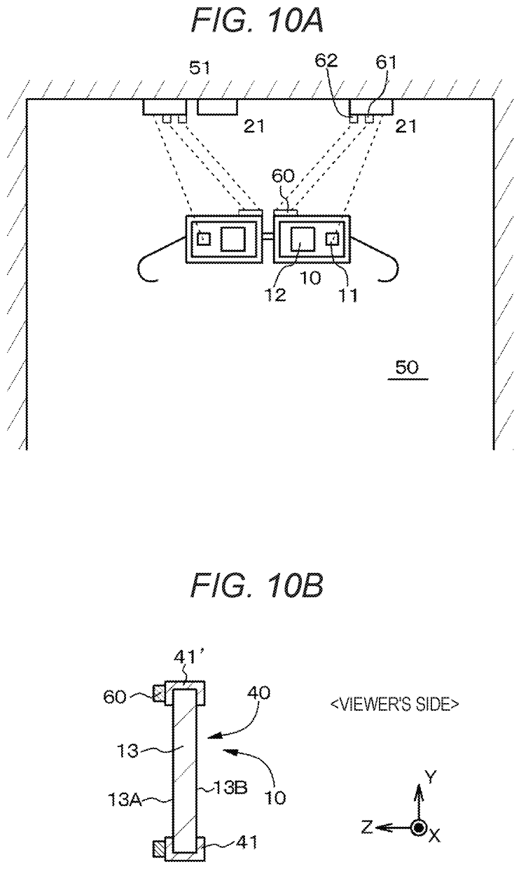

Example 3 is a modification of Example 1 to Example 2. A use example of the display device of Example 3 is shown in FIG. 10A. That is, FIG. 10A is a schematic diagram of a state where the display device of Example 3 is being used in a room. Image forming devices 21 are provided on a wall surface 51 of a room 50. If a viewer stands in a prescribed position of the room 50, an image sent from the image forming device 21 arrives at the optical splitter 11 included in the image display device 10, and the viewer can see this image via the light collecting element 12.

As shown in FIG. 10B, which is a schematic cross-sectional view of the image display device of Example 3 taken along the XZ plane, position display means 60 are installed in the image display device 10. Here, each of the position display means 60 includes a retroreflection marker.

Further, in the display device of Example 3, the position display means 60 are installed in the image display device 10, and a position detection means that detects the position of the position display means 60 is provided in the image forming device 21. Then, the position of an image emitted from the image forming device 21 is controlled on the basis of the result of detection of the position of the position display means 60 by the position detection means. As the position detection means, a light emitting diode 61 that emits infrared rays and an infrared sensor or infrared camera 62 that detects infrared rays returning from the retroreflection marker 60 may be given. It is preferable that a filter (an infrared transmission filter) that transmits infrared rays and blocks visible light be placed on the infrared incident side of the infrared sensor or infrared camera 62. Examples of the method for controlling the position of an image emitted from the image forming device 21 include a method in which a movable mirror (not illustrated) that an image emitted from the image forming device 21 is incident on is placed and an image reflected by the movable mirror capable of moving with respect to three axes is caused to be incident on the optical splitter 11. Thus, the position of the retroreflection marker 60 and further the position of the image display device 10 are detected by the position detection means, and the position of an image emitted from the image forming device 21 is controlled on the basis of the detection result; thereby, the image emitted from the image forming device 21 can be surely caused to arrive at the optical splitter 11.

Except the above respects, the configuration and the structure of the image display device or the display device of Example 3 may be similar to the configuration and the structure of the image display device or the display device of Example 1 to Example 2, and hence a detailed description is omitted.

Hereinabove, the present disclosure is described on the basis of preferred Examples; however, the present disclosure is not limited to these Examples. The configuration and the structure of the display device (the head-mounted display), the image display device, and the image forming device described in Examples are given as examples, and may be altered as appropriate. As an image to be divided by the optical splitter, other examples include a form in which division is made into three images in the vertical direction, a form in which an image is divided into three images in the horizontal direction and into three images in the vertical direction in a cross form (since one image including the center light course overlaps, this is a form in which division is made into a total of five images), a form in which an image is divided into two images in the horizontal direction and into two images in the vertical direction, i.e., 2×2=4, and a form in which an image is divided into three images in the horizontal direction and into three images in the vertical direction, i.e., 3×3=9.

The display device may include a plurality of image forming devices. That is, it is also possible to employ a configuration in which the display device includes a plurality of image forming devices between which the position where an image is emitted is different, the same image is emitted from the plurality of image forming devices, and one image among the plurality of images is received by one image display device. Then, thereby, the flexibility of the relative positional relationship between the image forming device and the viewer can be raised. That is, on the assumption that, for example, if a viewer is located in a prescribed position, an image sent from an image forming device arrives at an optical splitter included in an image display device and the viewer can see this image via a light collecting element, the margin of this prescribed position can be increased.

Note that the present disclosure may include the following configuration.
[A01] <<Image display device: first aspect>>

An image display device including:

an optical splitter to which an image emitted from an image forming device placed in an outside is injected and that is configured to divide the image into a plurality of images; and

a light collecting element configured to collect, on a pupil of a viewer, a plurality of images divided by the optical splitter and emitted from the optical splitter,

in which, if a focal distance of the light collecting element is denoted by F₀ (unit: mm) and an optical distance from the optical splitter to the light collecting element is by L₀ (unit: mm),

L₀=F₀±10

is satisfied.
[A02] <<Image Display Device: Second Aspect>>

An image display device including:

an optical splitter to which an image emitted from an image forming device placed in an outside is injected and that is configured to divide the image into a plurality of images; and

a light collecting element configured to collect, on a pupil of a viewer, a plurality of images divided by the optical splitter and emitted from the optical splitter,

in which, if an extension line of a center line of the pupil is taken as a Z-axis, a straight line connecting turning centers of left and right eyeballs is as an X-axis, and an axis orthogonal to the X-axis and the Z-axis and is as a Y-axis, the optical splitter and the light collecting element are provided in an imaginary plane parallel to an XY plane.
[A03] The image display device according to [A02], in which, if a focal distance of the light collecting element is denoted by Fo (unit: mm) and an optical distance from the optical splitter to the light collecting element is by L₀ (unit: mm),

L₀=F₀±10

is satisfied.
[A04] <<Image Display Device: Third Aspect>>

An image display device including:

an optical splitter to which an image emitted from an image forming device placed in an outside is injected and that is configured to divide the image into a plurality of images; and

a light collecting element configured to collect, on a pupil of a viewer, a plurality of images divided by the optical splitter and emitted from the optical splitter,

in which the optical splitter is provided on an ear side of the viewer, and the light collecting element is provided on a nose side of the viewer.

[A05] The image display device according to [A04], in which, if a focal distance of the light collecting element is denoted by F₀ (unit: mm) and an optical distance from the optical splitter to the light collecting element is by L₀ (unit: mm),

L₀=F₀±10

is satisfied.
[A06] The image display device according to [A04] or [A05], in which if an extension line of a center line of the pupil is taken as a Z-axis, a straight line connecting turning centers of left and right eyeballs is as an X-axis, and an axis orthogonal to the X-axis and the Z-axis and is as a Y-axis, the optical splitter and the light collecting element are provided in an imaginary plane parallel to an XY plane.
[A07] The image display device according to any one of [A01] to [A06], in which a light beam included in an image incident on the optical splitter is parallel light, and also a light beam included in each of a plurality of images emitted from the optical splitter is parallel light.
[A08] The image display device according to any one of [A01] to [A07], in which a plurality of images divided by the optical splitter and formed on a retina of the viewer is the same image. [A09] The image display device according to any one of [A01] to [A08], in which a plurality of images divided by the optical splitter is directly incident on the light collecting element.
[A10] The image display device according to [A09], in which the optical splitter includes a reflective diffraction grating or a reflective hologram diffraction grating, or a transmission diffraction grating or a transmission hologram diffraction grating, and

the light collecting element includes a hologram lens.
[A11] The image display device according to any one of [A01] to [A09], in which a plurality of images divided by the optical splitter is reflected once or more, and is incident on the light collecting element.
[A12] The image display device according to [A11], in which the optical splitter includes a transmission diffraction grating or a transmission hologram diffraction grating, or a reflective diffraction grating or a reflective hologram diffraction grating,

the light collecting element includes a hologram lens, and

a light reflection member configured to reflect, toward the light collecting element, light emitted from the optical splitter is further provided.
[A13] The image display device according to any one of [A01] to [A12], in which an amount of displacement on the pupil of the viewer between a plurality of images divided by the optical splitter is not less than 2 mm and not more than 7 mm.
[A14] The image display device according to any one of [A01] to [A13], in which division is made into at least two images by the optical splitter.
[A15] The image display device according to any one of [A01] to [A14], in which the light collecting element includes a hologram lens.
[A16] The image display device according to any one of [A01] to [A15], in which the optical splitter includes a diffraction grating or a volume hologram diffraction grating.
[A17] The image display device according to any one of [A01] to [A16], in which a position display means is installed.
[A18] The image display device according to [A17], in which the position display means includes a retroreflection marker.
[A19] The image display device according to any one of [A01] to [A18], in which the image forming device is placed more on a front side than the viewer.
[A20] The image display device according to any one of [A01] to [A19], configured to be mounted on a head of the viewer.
[B01] <<Display Device>>

A display device including:

an image forming device; and an image display device,

in which the image display device includes the image display device according to any one of [A01] to [A20].
[B02] The display device according to [B01], in which a position display means is installed in the image display device,

a position detection means configured to detect a position of the position display means is provided in the image forming device, and

a position of an image emitted from the image forming device is controlled on the basis of a result of detection of the position of the position display means by the position detection means.

### REFERENCE SIGNS LIST

10 Image display device
11, 11A, 11B Optical splitter
12 Light collecting element
13 Base material
13A First surface of base material
13B Second surface of base material
13C Oblique surface of base material
14 Light reflection member
21 Image forming device
31 Viewer
32 Pupil
33 Retina
40 Frame
41 Front section
41′ Rim section
42 Hinge
43 Temple section
44 End cover section
50 Room
51 Wall surface
52 Seat
60 Position display means (retroreflection marker)
61 Light emitting diode
62 Infrared sensor or infrared camera
110 Image forming device
111 Organic EL display device
113A First convex lens
113B Second convex lens
114 Diaphragm
115 Casing
210 Image forming device
211 Light source
212 Scanning means
213 Lens system
215 Casing

1. An image display device comprising:
an optical splitter to which an image emitted from an image forming device placed in an outside is injected and that is configured to divide the image into a plurality of images; and
a light collecting element configured to collect, on a pupil of a viewer, a plurality of images divided by the optical splitter and emitted from the optical splitter,
wherein, if a focal distance of the light collecting element is denoted by F₀ (unit: mm) and an optical distance from the optical splitter to the light collecting element is by L₀ (unit: mm),
L₀=F₀±10
is satisfied.

2. An image display device comprising:
an optical splitter to which an image emitted from an image forming device placed in an outside is injected and that is configured to divide the image into a plurality of images; and
a light collecting element configured to collect, on a pupil of a viewer, a plurality of images divided by the optical splitter and emitted from the optical splitter,
wherein, if an extension line of a center line of the pupil is taken as a Z-axis, a straight line connecting turning centers of left and right eyeballs is as an X-axis, and an axis orthogonal to the X-axis and the Z-axis and is as a Y-axis, the optical splitter and the light collecting element are provided in an imaginary plane parallel to an XY plane.

3. An image display device comprising:
an optical splitter to which an image emitted from an image forming device placed in an outside is injected and that is configured to divide the image into a plurality of images; and
a light collecting element configured to collect, on a pupil of a viewer, a plurality of images divided by the optical splitter and emitted from the optical splitter,
wherein the optical splitter is provided on an ear side of the viewer, and the light collecting element is provided on a nose side of the viewer.

4. The image display device according to claim 1, wherein a light beam included in an image incident on the optical splitter is parallel light, and also a light beam included in each of a plurality of images emitted from the optical splitter is parallel light.

5. The image display device according to claim 1, wherein a plurality of images divided by the optical splitter and formed on a retina of the viewer is a same image.

6. The image display device according to claim 1, wherein a plurality of images divided by the optical splitter is directly incident on the light collecting element.

7. The image display device according to claim 6, wherein the optical splitter includes a reflective diffraction grating or a reflective hologram diffraction grating, or a transmission diffraction grating or a transmission hologram diffraction grating, and
the light collecting element includes a hologram lens.

8. The image display device according to claim 1, wherein a plurality of images divided by the optical splitter is reflected once or more, and is incident on the light collecting element.

9. The image display device according to claim 8, wherein the optical splitter includes a transmission diffraction grating or a transmission hologram diffraction grating, or a reflective diffraction grating or a reflective hologram diffraction grating,
the light collecting element includes a hologram lens, and
a light reflection member configured to reflect, toward the light collecting element, light emitted from the optical splitter is further provided.

10. The image display device according to claim 1, wherein an amount of displacement on the pupil of the viewer between a plurality of images divided by the optical splitter is not less than 2 mm and not more than 7 mm.

11. The image display device according to claim 1, wherein division is made into at least two images by the optical splitter.

12. The image display device according to claim 1, wherein the light collecting element includes a hologram lens.

13. The image display device according to claim 1, wherein the optical splitter includes a diffraction grating or a volume hologram diffraction grating.

14. The image display device according to claim 1, wherein a position display means is installed.

15. The image display device according to claim 14, wherein the position display means includes a retroreflection marker.

16. The image display device according to claim 1, wherein the image forming device is placed more on a front side than the viewer.

17. The image display device according to claim 1, configured to be mounted on a head of the viewer.

18. A display device comprising:
an image forming device; and an image display device, wherein the image display device includes the image display device according to claim 1.

19. The display device according to claim 18, wherein a position display means is installed in the image display device,
a position detection means configured to detect a position of the position display means is provided in the image forming device, and
a position of an image emitted from the image forming device is controlled on a basis of a result of detection of the position of the position display means by the position detection means.
